(19) United States
(12) Patent Application Publication
(10) Pub. No.: US 2004/0178927 A1
(43) Pub. Date: Sep. 16, 2004

(54) Vehicle signalling system

(76) Inventor: Giovanni Fabris, Vidor (IT)

Correspondence Address: Hall Priddy, Myers & Vande Sande, Suite 200, 10220 River Road, Potomac, MD, 20854, US

(21) Appl. No.: 10/467,443

(22) PCT Filed: Feb. 5, 2002
(86) PCT No.: PCT/IT02/00069

(30) Foreign Application Priority Data
Feb. 6, 2001 (IT) BO01A000061

(51) Int. Cl. G08G 1/09

(52) U.S. Cl. 340/905; 340/907

(57) ABSTRACT

Vehicle signalling system (1) comprising a trnsmission unit (5) that can be installed close to a road sign (3) containing a road warning (INF) and having a pre-set relevant road direction (DIR), the transmission unit (5) being designed to transmit a warning signal (Savv) codifying a first piece of information indicating the relevant road direction (DIR) and a second piece of information indicating the road warning (INF) associated with the respective road sign (3); the vehicle signalling system (1) furthermore comprises at least one reception unit(6) that can be installed in a vehicle (2) to identify the direction of movement (SPO) of the vehicle (2).

### TECHNICAL FIELD

The present invention concerns a vehicle signalling system.

### BACKGROUND ART

As is known, in currently existing vehicle signalling systems, like road sign systems for example, road signs are used, each of which is positioned close to the edge of the road in a direction such as to make a given piece of road information indicating, for example, the presence of danger on the road, a road prohibition or obligation, visible to the users of the vehicles travelling along the road towards the road sign itself.

The above-mentioned vehicle signalling systems have the disadvantage of requiring, in order to communicate the road information to the vehicle user, the user to distract his attention for a moment from the road along which he is travelling, to look at the image or message displayed by the road sign.

Obviously the time necessary for acquiring the above information depends to a considerable extent on the road visibility conditions which are drastically reduced at night or in fog or rain.

In particular, in the above-mentioned cases, the user has to distract his attention at length from the road he is travelling along and this can therefore create a hazard.

Further known systems include vehicle signalling systems comprising a transmission device generally installed at a road danger point, for example a dangerous bend, designed to transmit a radio frequency signal indicating the presence of a hazard, and a reception device installed in the vehicle, designed to receive said signal transmitted by said transmission device when the vehicle is near a road danger point, in order to warn the vehicle user of the presence of a hazard.

The above-described vehicle signalling systems have the disadvantage of transmitting said road hazard to all the vehicles that are approaching the point at which the transmitter device is installed, regardless of their direction of movement, erroneously also warning vehicles that are not interested in the hazard as they are travelling, for example, in a direction of movement opposite to the hazard direction.

### DISCLOSURE OF INVENTION

The aim of the present invention is therefore to produce a vehicle signalling system free from the disadvantages described above.

According to the present invention a vehicle signalling system is produced, as described in claim 1.

### BRIEF DESCRIPTION OF THE DRAWINGS

The present invention will now be described with reference to the attached drawings, which illustrate a non-restrictive embodiment example, in which:

FIG. 1 illustrates a vehicle signalling system produced according to the present invention;

FIG. 2 shows a block diagram of a transmission unit present in the vehicle signalling system of FIG. 1;

FIG. 3 illustrates a block diagram of a reception unit present in the vehicle signalling system of FIG. 1; and

FIG. 4 illustrates a block diagram relating to the operations performed by the vehicle signalling system of FIG. 1.

### BEST MODE FOR CARRYING OUT THE INVENTION

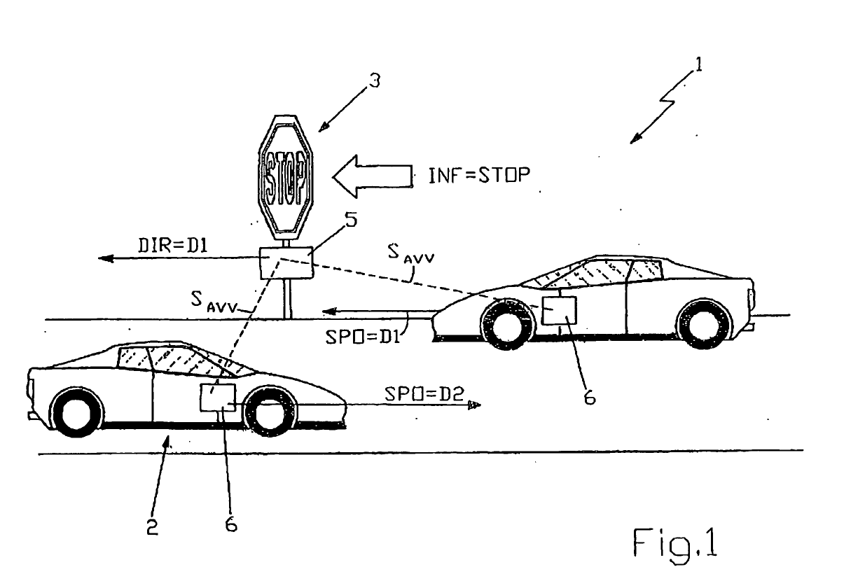

With reference to FIG. 1, number 1 indicates overall a vehicle signalling system designed to transmit a piece of road information INF that can be interpreted only by users of vehicles 2, for example cars, motorbikes and similar, which have a direction and path of movement substantially equal to a pre-set direction and path respectively.

In particular, the vehicle signalling system 1 has the aim of communicating in advance a piece of road information INF, associated with a road sign 3, only to the user of a vehicle 2, the movement direction SPO of which is substantially equal to the relevant direction DIR of the road sign 3, which corresponds to the direction and path of movement (of the vehicle 2), enabling the user of the vehicle 2 to view the road information INF associated with the road sign 3.

In the example illustrated in FIG. 1, the vehicle signalling system 1 (which will be described in detail below) is designed to communicate the road information INF associated for example with a road sign 3, with a relevant direction DIR=D1, only to the vehicle 2 with movement direction SPO (SPO=D1) substantially equal to the relevant road direction DIR (DIR=D1), excluding from communication of the road information INF the user of a vehicle 2 with a movement direction SPO (in the example illustrated SPO=D2<>D1) substantially different from the relevant direction DIR.

In the example illustrated in FIG. 1, the vehicle signalling system 1 comprises: a transmission unit 5 that can be installed close to the road sign 3, designed to transmit a warning signal S_{AVV} codifying a first piece of information indicating the relevant road direction DIR, and a second piece of information indicating the road information INF associated with the respective road sign 3.

The vehicle signalling system 1 comprises, furthermore, a reception unit 6 that can be installed in a vehicle 2, designed to determine at all times the direction of movement SPO of the vehicle 2 and to D receive and decode the warning signal S_{AVV} transmitted by the transmission unit 5, in such a way as to communicate to the user of the vehicle 2 the road information INF when the vehicle 2 has a direction of movement SPO substantially equal to the relevant road direction DIR codified in the warning signal S_{AVV}.

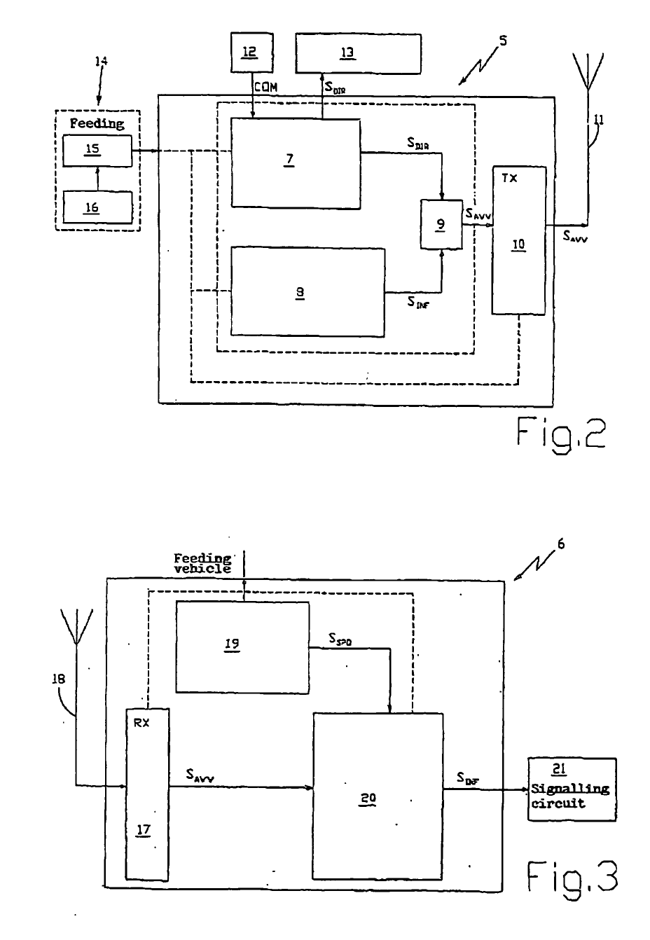

With reference to FIG. 2, the transmission unit 5 comprises: a first generator circuit 7 designed to provide at the output a direction signal S_{DIR} indicating the pre-set relevant direction DIR; a second generator circuit 8 designed to provide at the output an information signal S_{INF} codifying a given piece of road information INF; a codifying circuit 9 designed to produce at the output the warning signal S_{AVV} comprising the direction signal S_{DIR} and the information signal S_{INF}; a transmission circuit 10 designed to activate, via an aerial 11, transmission of the warning signal S_{AVV}.

The first generator circuit 7 can be defined, for example, by an oscillator circuit designed to generate, according to a command signal COM received at the input, the direction signal S_{DIR} codifying a given relevant direction DIR.

The command signal COM, in the example illustrated in FIG. 2, is provided with an adjustment device 12 of known type, which is included in the transmission unit 5 and is designed to permit manual drive (variation of the COM command signal) of the first generator circuit 7 in order to select the relevant direction DIR codified by the direction signal S_{DIR}.

Preferably, but not necessarily, the transmission unit 5 is provided, furthermore, with a display device 13 of known type, for example a liquid crystal display, receiving at input the direction signal S_{DIR} and permitting display of the relevant direction DIR selectable via the adjustment device 12.

The second generator circuit 8 can be defined, for example, by an oscillator circuit which is able to codify in the information signal S_{INF} a certain piece of road information INF (dangerous bend to the right, speed limit, stop, etc.).

The transmission circuit 10 can be advantageously defined by a transmitter, which is connected downstream of the codification circuit 9, from which it receives the warning signal S_{AVV}, and is designed to command transmission, for example in radio frequency, of the latter via the aerial 11.

From the above description it should be pointed out that the transmission circuit 10 is designed to transmit the warning signal S_{AVV} with a pre-set power so that the latter can be received by the reception unit 6 at an appropriate distance.

Finally, the transmission unit 5 comprises a power source 14 designed to power the first and second generator circuit 7, 8 and the transmission circuit 10 and comprising a battery 15 and a solar panel 16 connected to the battery 15 to constantly recharge the latter in order to make the transmission unit 5 completely independent from the energy point of view and therefore installable in any area, also without any type of electricity supply.

With reference to FIG. 3, the reception unit 6 comprises: a reception circuit 17, which is connected to an aerial 18 to receive and decode the warning signal S_{AVV} transmitted by the transmission unit 5, in such a way as to provide at the output the warning signal S_{AVV} in an electronic format; a position indicator circuit 19 designed to determine at all times the movement direction SPO of the vehicle 2 in order to provide at the output a movement signal S_{SPO} indicating the movement direction SPO; a central control unit 20 designed to receive and process the warning signal S_{AVV} and the movement signal S_{SPO} in order to provide or otherwise at the output the information signal S_{INF} included in the warning signal S_{AVV}; a signalling circuit 21 designed to obtain from the information signal S_{INF} the road information INF in order to automatically communicate the latter to the user of the vehicle 2.

The reception circuit 17 can be advantageously defined by a receiver which is positioned between the aerial 18, from which it receives the warning signal S_{AVV}, and the central control unit 20 in order to supply the warning signal S_{AVV} converted into an electronic format to the central control unit 20.

The position indicator circuit 19 is of known type and can be advantageously defined by an electronic compass (the operation of which is known and is therefore not described in detail) or similar, which provides at all times the movement signal S_{SPO}, indicating the movement direction SPO of the vehicle 2.

In the example illustrated in FIG. 3, the central control unit 20 is connected downstream both of the position indicator circuit 19, from which it receives at the input the movement signal S_{SPO}, and of the reception circuit 17, from which it receives the warning signal S_{AVV}, and is designed to decode the latter to obtain the direction signal S_{DIR} and the information signal S_{INF}.

In detail, the central control unit 20, after decoding of the warning signal S_{AVV}, is designed to process the direction signal S_{DIR} and the movement signal S_{SPO} to ascertain whether the vehicle 2 is interested or not in the road information INF contained in the information signal S_{INF}, in other words it filters the warning signal S_{AVV} in order to communicate the information signal S_{INF} only when the relevant direction DIR codified in the direction signal S_{DIR} is substantially equal to the movement direction SPO codified in the movement signal S_{SPO}.

More in detail, the central control unit 20 performs a comparison between the movement signal S_{SPO} and the direction signal S_{DIR} codified in the warning signal S_{AVV} and enables or disables transmission of the information INF, included in the information signal S_{INF}, to the signalling circuit 21 when the direction of movement SPO of the vehicle 2 codified in the direction signal S_{SPO} is substantially equal to or respectively different from the relevant direction DIR codified in so the direction signal S_{DIR}.

The signalling circuit 21 is designed to receive at the input the information signal S_{INF} and to automatically produce at the output an acoustic or visual signal that can be perceived by the user of the vehicle 2 interested, indicating the road warning.

In particular, the signalling circuit 21 can be decoding of the warning signal S_{AVV}, is designed to process the direction signal S_{DIR} and the movement signal S_{SPO} to ascertain whether the vehicle 2 is interested or not in the road information INF contained in the information signal S_{INF}, in other words it filters the warning signal S_{AVV} in order to communicate the information signal S_{INF} only when the relevant direction DIR codified in the direction signal S_{DIR} is substantially equal to the movement direction SPO codified in the movement signal S_{SPO}.

More in detail, the central control unit 20 performs a comparison between the movement signal S_{SPO} and the direction signal S_{DIR} codified in the warning signal S_{AVV} and enables or disables transmission of the information INF, included in the information signal S_{INF}, to the signalling circuit 21 when the direction of movement SPO of the vehicle 2 codified in the direction signal S_{SPO} is substantially equal to or respectively different from the relevant direction DIR codified in the direction signal S_{DIR}.

The signalling circuit 21 is designed to receive at the input the information signal S_{INF} and to automatically produce at the output an acoustic or visual signal that can be perceived by the user of the vehicle 2 interested, indicating the road warning.

In particular, the signalling circuit 21 can be defined, for example, by a display that can be installed or integrated for example in the dashboard (not illustrated) of the vehicle 2 designed to display, according to the road information INF received, a corresponding image indicating, for example, signalling of a prohibition, a speed limit, an obligation or other.

From the above description it should be pointed out that in the example illustrated in FIG. 3, the reception unit is designed to be powered by the power supply circuit (not illustrated) present in the vehicle 2.

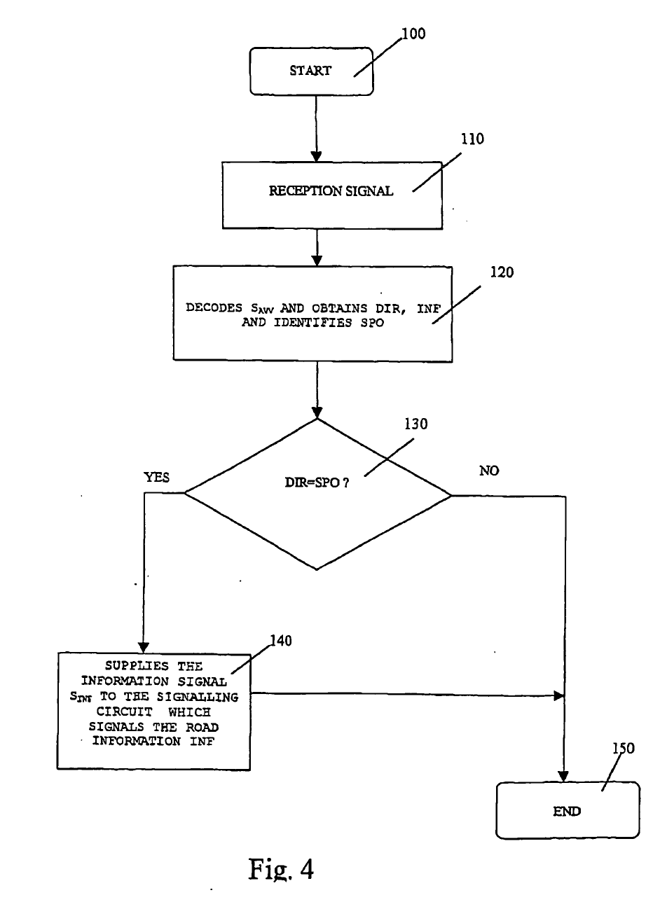

Operation of the vehicle signalling system 1 will now be described with reference to FIG. 4.

Starting from block 100, it is assumed that the vehicle 2 is travelling towards a road sign 3, in which the transmission unit 5 is installed.

It is furthermore assumed that in the transmission unit 5 the relevant direction DIR has been pre-set.

Block 100 is followed by block 110 in which, subsequent to the vehicle 2 approaching (at an appropriate distance) the road sign 3, the reception unit 6 installed in the vehicle 2 receives the warning signal S_{AVV} transmitted by the transmission unit 5.

Block 110 is followed by block 120, in which the central control unit 20 present in the reception unit 6 decodes the warning signal S_{AVV} and obtains from the latter the direction signal S_{DIR} and the information signal S_{INF}.

In block 120 the central control unit 20 furthermore identifies the relevant direction DIR and the movement direction SPO of the vehicle 2 by processing the direction signal S_{DIR} and the movement signal S_{SPO} respectively, provided by the position indicator circuit 19.

Block 120 is followed by block 130, in which the central control unit 20 performs a comparison between the direction of movement SPO of the vehicle 2 and the relevant direction DIR.

If the direction of movement SPO of the vehicle 2 is substantially equal to the relevant direction DIR, block 130 is followed by block 140, in which the central control unit 20 supplies the information signal S_{INF} to the signalling circuit 21 which signals the road information INF, via an acoustic or visual message, to the user of the vehicle 2. Block 140 is followed by block 150 indicating the end of the signalling.

If on the other hand the direction of movement SPO of the vehicle 2 is substantially different from the relevant direction DIR, block 120 is followed by block 150 indicating the end of signalling.

The advantages of the vehicle signalling system 1 are evident: the system automatically communicates to the vehicle user the road information normally shown by the road signs so that the user does not distract his attention from the road he is travelling along (to view the road information), consequently eliminating the hazard caused by said distraction.

A further advantage of the vehicle signalling system is that the road information is communicated only to the vehicles affected by the hazard or prohibition or other, thus excluding all vehicles not subject to the road condition indicated in the information.

Lastly, the vehicle signalling system has the advantage of being relatively inexpensive,

simple to produce and easy to install due to the use of widely available low cost electronic components.

It should also be pointed out that the present invention can also be applied in other vehicle transport systems, for example transport by ship, aeroplane or train and more generally in any transport system requiring communication of information to means of transport that move in a given direction and path.

Lastly it is clear that modifications and variations can be made to the vehicle signalling system described and illustrated here while remaining within the scope of the present invention.

In particular, the transmission unit 2 can comprise, as an alternative to the first generator circuit 7, a position indicator circuit defined by an electronic compass (similar to the position indicator circuit 19 present in the reception unit 5) designed to provide at the output the direction signal S_{DIR} indicating a given relevant direction DIR.

Furthermore it should be pointed out that the position indicator circuit 19 can consist of a navigation device comprising a satellite receiver of known type (GPS) able to use the signals emitted by a certain number of satellites in stationary orbit in order to determine, moment by moment, the position and direction of movement SPO of the vehicle 2 in order to provide at the output a movement signal S_{SPO} of the vehicle 2.

Furthermore it is evident that the first and second generator circuit 7 and 8 and the codification circuit can be advantageously defined by a microcontroller of known type designed to permit pre-setting and storage, inside it, of the relevant direction DIR and the road information INF, and to provide at the output the warning signal S_{AVV} codifying the relevant direction DIR and the road information INF.

1. Vehicle signalling system (1) characterised in that it comprises:
at least one transmission unit (5) that can be installed close to a road sign (3) having a relevant road direction (DIR) and indicating a road warning (INF), said transmission unit (5) being designed to transmit a warning signal (S_{AVV}) codifying a first piece of information indicating said relevant road direction (DIR) and a second piece of information indicating the road warning (INF) associated with the respective road sign (3);
at least one reception unit (6) that can be installed in a vehicle (2) designed to determine the direction of movement (SPO) of the vehicle (2) and receive and decode said warning signal (S_{AVV}) to obtain the relevant direction (DIR) and the road warning (INF), the reception unit (6) being designed to communicate to the user of the vehicle (2) the road warning information (INF) when the direction of movement (SPO) of said vehicle (2) satisfies a pre-established relation with said relevant road direction (DIR).

2. System according to claim 1, characterised in that said pre-established relation is satisfied when said direction of movement (SPO) of said vehicle (2) is substantially equal to said relevant road direction (DIR).

3. System according to one of the claims 1 or 2, characterised in that said reception unit (6) comprises position indicator devices (19) designed to provide at the output a position signal (S_{SPO}) indicating the direction of movement (SPO) of said vehicle (2).

4. System according to any one of the previous claims, characterised in that said transmission unit (5) comprises transmission devices (10) designed to transmit said warning signal (S_{AVV}).

5. System according to claim 4, characterised in that said reception unit (6) comprises reception devices (17) designed to receive and decode said warning signal (S_{AVV}) transmitted by said transmission devices (10).

6. System according to any one of the previous claims, characterised in that said transmission unit (6) comprises generator devices (7, 8, 9) designed to generate said warning signal (S_{AVV}).

7. System according to any one of the claims from 2 to 6, characterised in that said reception unit (6) comprises central control devices (20) designed to obtain from said warning signal (S_{AVV}) said relevant road direction (DIR) and said direction of movement (SPO) of said vehicle (2), said central control devices (20) being designed to compare said relevant road direction (DIR) with said direction of movement (SPO) of said vehicle (2) in order to provide at the output a signal (S_{INF}) indicating the road information (INF) contained in said warning signal (S_{AVV}).

8. System according to claim 7, characterised in that said reception unit (6) comprises signalling devices (21) designed to communicate to the user of said vehicle (2) the road information (INF) contained in said warning signal (S_{AVV}).

9. System according to any one of the previous claims, characterised in that said transmission unit (5) comprises power devices (14) designed to power the transmission unit (5) and comprising a solar panel (16) and a battery (15).

10. System according to any one of the claims from 3 to 9, characterised in that said position indicator devices (19) comprise an electronic compass.

11. System according to any one of the claims from 3 to 9, characterised in that said position indicator devices (19) comprise a satellite receiver.

12. System according to any one of the claims from 6 to 11, characterised in that said generator devices (7, 8, 9) comprise first signal generator devices (7) designed to provide at the output a direction signal (S_{DIR}) indicating said relevant direction (DIR), second signal generator devices (8) designed to provide at the output an information signal (S_{INF}) indicating said road warning (INF), and codification devices (9) designed to codify the direction signal (S_{DIR}) and the information signal (S_{INF}) in the warning signal (S_{AVV}).

13. System according to claim 12, characterised in that said first signal generator devices (7) comprise an electronic compass.
